(19) United States
(12) Patent Application Publication
(10) Pub. No.: US 2016/0285171 A1
(43) Pub. Date: Sep. 29, 2016

(54) Flexible Asymmetric Radio Frequency Data Shield

(71) Applicant: John Bernard Moylan, Wahroonga (AU)

(72) Inventor: John Bernard Moylan, Wahroonga (AU)

(21) Appl. No.: 14/672,078

(22) Filed: Mar. 27, 2015

(51) Int. Cl. H01Q 17/00; B32B 15/14; B32B 7/12; B32B 5/02; B32B 5/26

(52) U.S. Cl. CPC H01Q 17/005; B32B 5/022; B32B 5/024; B32B 5/028; B32B 5/26; B32B 7/12; B32B 15/14; B32B 2250/42; B32B 2262/103; B32B 2307/202; B32B 2307/206; B32B 2307/212; B32B 2519/02; B32B 2571/00

(57) ABSTRACT

The present invention is a thin and flexible asymmetric radio frequency shield in the form of a multi layered sheet, offering a high level of electromagnetic shielding in terms of radio frequency signal penetration through the thickness of the shield, one side of which is electrically conducting and reflects radio frequency signals while the other side is electrically insulating and absorbs radio frequency signals. Embodiments include a shield placed in the outer currency compartment of a wallet whereby the contents are shielded, while allowing a frequently used RFID card or document, such as a travel or identity card to be used without needing to be removed from the wallet. The shield may also be used in any other circumstance where a thin and flexible asymmetric radio frequency shield of such a nature is of utility.

### CROSS REFERENCE TO RELATED APPLICATIONS

n/a

### STATEMENT OF FEDERALLY SPONSORED RESEARCH OR DEVELOPMENT

n/a

### BACKGROUND

The present invention relates to the protection of personal information contained on contactless payment and identification devices, which are becoming ever more common in the modern world. These include contactless smart cards as defined under ISO/IEC 14443, ISO/IEC 15693, as well as documents, such as passports as defined under ICAO 9303 and ISO/IEC 14443. These are forms of Radio Frequency Identification Device (RFID) or Proximity Integrated Circuit Card (PICC). Devices of this sort include public transport access cards such as Opal and Oyster cards, Credit cards, as well as passports.

RFID devices of this sort contain an integrated circuit and an antenna consisting of a loop of conducting material, as well as circuitry needed to process the signal from a card or document reader into a form compatible with the integrated circuit, harvest power from the reader signal to power the device, and transmit a return signal. The reader unit contains a loop antenna, which emits a short range radio frequency field, as well as the circuitry necessary to receive and process signals from the RFID device, and allow payment or identification to take place (Atmel, 2005).

When these devices are within range of the reader power is transmitted from the reader unit to the card/document by inductive coupling, the loop aerial in the reader unit and that in the card/document effectively making up a transformer (FIG. 1). A sinusoidal alternating electric current in the reader loop antenna produces a sinusoidal continuously varying magnetic field at radio frequency; this induces a sinusoidal alternating current to be produced in the loop antenna of the card/document. Data is transmitted from the reader unit to the card/document by amplitude modulation of a 13.57 MHz carrier frequency. The signal received by the card is converted into a binary form, and then processed by the integrated circuit. Provided that required parameters are met, the integrated circuit uses the antenna coil built into the card or passport to transmit data back to the reader by a similar mechanism, but using a carrier frequency of 847.5 kHz. The energy used to power both the integrated circuit and transmitter within the device come from the reader unit, meaning that these devices must be close to the reader to operate, and therefore operate over a limited range. Typically these devices operate at distances of less than 10 cm (ISO/IEC 14443) but some devices can operate at distances of up to 50 cm (ISO/IEC 15693) (Atmel, 2005). As such these devices operate in a near field environment and the magnetic component of the signal predominates, both reader and card signals are effectively magnetic fields the polarity of which alternate at radio frequencies (Agbinya, 2013, Weibler, 1993).

The amount of energy that can be collected by a loop antenna, such as those contained in RFID devices of this sort, depends on the relative orientation of the antenna to the direction of magnetic flux. The maximum power transfer occurs when the antenna is at 90 degrees to the direction of magnetic flux (magnetic field), that is the reader loop antenna is aligned with and parallel to the RFID loop antenna and drops to zero when the antenna is parallel to the magnetic field, varying with the cosine of the angle between the normal to the antenna plane and the flux field direction (FIG. 2) (Young & Freedman, 2000).

RFID enabled smart cards and documents offer increased convenience, but also expose the user to the possibility of information theft. The information contained on RFID devices can be accessed at a distance, in such a way that the owner or user of the device is unaware that this has occurred, and the data harvested used for fraud or other criminal purpose (Greenberg, 2012). A convenient method of protecting information contained on RFID devices is needed, while allowing easy use of frequently used cards, such as public transport cards.

There are several solutions available to provide data protection for personal information stored on RFID cards. These mainly rely on blocking the power signal by reflection, using properties of conductors described by well established physical principles. These properties were investigated by Michael Faraday during the nineteenth century in his ice pail experiment, as well as in earlier, but less rigorous, experiments conducted during the eighteenth century by both Benjamin Franklin and Michael Priestly. These properties of conductors underlie electrostatic shielding, and are embodied in the Faraday Cage (Young & Freedman, 2000). Amongst the most effective of these devices is the simplest, placing a sheet of aluminium foil in the outer part of a wallet, or using aluminium foil to wrap individual cards. Aluminium foil, in the form of small strips dropped from aircraft, was used during WWII to subvert enemy radar from the middle of 1943(Department of the Airforce, 1989). A 1995 article in the New York Times reports that shoplifters in the United States were using aluminium foil lined bags, and other portable containers of all types capable of containing an item or items equipped with an RFID tag or tags, including, but not limited to, bags, boxes, pouches, pockets, and items of clothing including boxer shorts and other items of personal apparel, to evade RFID security systems, and the same article reports the use of Duct Tape for the same purpose, some types at least of which have a high enough metal content to block RFID security systems. These items included articles both constructed from, or incorporating in their construction a conductive material, the boxer shorts mentioned above are specifically stated to have been made from metal. This article contains sufficient detail for people of appropriate knowledge and skill to produce such items (MacFarquhar, Mar. 11, 1995). A Feb. 8 1996 article in Rolling Stone magazine describes Chris Cornell, from the band Soundgarden, constructing a duct tape wallet over the course of an interview, and reports Cornell as stating that he made such a wallet every time a new album was released, most recently 17 months earlier (Cross, 1996). The use of Aluminium foil is described in published materials in relation to blocking RFID card signals as early as 2003 (Kantor, 2003), and the use of aluminium foil in wallets, for the purposes of RFID security, is described in published materials as early as 2004 (Spy Blog, Feb. 21, 2004).

Wallets are available incorporating RF blocking fabric, the most effective of which behave similarly to metallic foil (Oxley, et. al., 2007), and solid aluminium wallets are also available. Patents related to the use of radio frequency blocking fabric, or else using a single layer of radio frequency blocking material, when the nature of this material is not specified, to provide radio frequency shielding of portable containers are numerous. Other solutions involving radio frequency reflective coatings of various materials are also available.

Published information indicates that, at least some commercially available radio frequency shielded wallets have been found, upon testing, either to be ineffective, or to function less effectively than previously published public domain methods of applying radio frequency shielding to similar containers (Pawlarczyk, 2013). These solutions, of varying effectiveness and durability, generally require the removal of cards from the protective device or wallet, or the opening of the protective device or wallet, in order for them to be used. Many people, for example those using public transport, wish, however, to simply be able to swipe their wallets without the need to first remove the RFID card or document.

When a radio frequency signal is reflected from a conducting material it is reflected 180 degrees out of phase with the incoming signal, and therefore destructively interferes with the incoming signal (Young & Freedman, 2000). This creates a near surface damping effect, so that an RFID held against or near a conducting surface, cannot be read. In practice it is therefore not possible to position an opal, oyster, or other frequently used RFID card on or close to the outside of a conductive shield, or in an outer compartment of a RF blocking wallet or other container utilising a conductive shield, and be able to use the card without removing it from the wallet or container. Tests, carried out by the author using stainless steel, copper and aluminium foils as well as radio frequency attenuating cloth, have shown that at best the card will be unreadable, and at worst will simply not be detected by the reader. Devices of a nature as described above are considered to be unworkable in terms of utility of a RFID device mounted outside the shielded enclosure, but near to or in contact with the shielding material, unless the shielding material used is of such a nature as to be ineffective in shielding items contained within the shielded enclosure.

Radio frequency absorbing materials are available, that function at appropriate wavelengths. Radio frequency absorption by seawater was observed during the 1940's development of Radar, and the use of ferrites, iron oxide compounds, such as magnetite, for this purpose has been noted as early as the 1950's (Schneyderman, 1965). The Magnetic properties of Magnetite have been known since at least the sixth century BC in the west, and fourth century BC in China (Rjwilmsi, 2015). Magnetite, in the form of a powder distributed through a non conducting matrix, absorbs most strongly at lower frequencies, with an absorption peak at approximately 8 to 12 MHz (Su et. al. 2012). Absorption of radio frequency energy by compounds with either a high electric or magnetic dipole occurs via the process of hysteresis, related to the time delay in these dipoles alignment with an applied electrical or magnetic field. The energy absorbed via hysteresis is transformed into heat, and this process is important in induction heating, however the amount of heat produced in the absorption of either radio or radar waves is usually negligible (Britannica). The term Hysteresis was first used to describe this phenomenon in 1890 by Sir James Alfred Ewing, and our current understanding of the process owes much to Soviet research during the 1970's by a group mathematicians led by Mark Alexandrovich Krasnosel'skii (Offsure, 2015). Research into the absorption of radio frequency energy increased in response to the rapid development of Radar during the 1960's. In a paper published in 1965, in the former Soviet Union, the use of ferrites and dielectric materials, for the absorption of radio frequency energy, and their application in the form of particles suspended in a rubber, or other non conducting matrix materials, to create what are termed heterogeneous materials, as well as graduated and layered radio frequency absorbing shields are discussed in detail individual (Schneyderman, 1965). Research into the use of ferrite particles, and specifically of magnetite, distributed through both natural rubber and plastic materials, and their use as radio frequency absorbers has continued to the present day, as ferrites, such as magnetite, are generally considered to be superior to other materials used for the same purpose as a result of both their dielectric and magnetic characteristics (Kong et. al., 2010).

Radio frequency absorbing materials would allow the use of a RFID device held against their surface, on the reader side of the shield, as they do not produce a near surface damping effect. These materials are, however, at the present time, of insufficient attenuation to be used to provide shielding of RFID devices at reasonable thickness. These materials are also, at the current time, expensive and can be difficult to obtain.

Patent applications related to RFID shielding wallets and other articles include EP2809193, US20140034520, and WO2013116532 filed on 31 Jan. 2013 by Paul Scicluna, which claims priority based on a provisional patent application Ser. No. 61/593,257, filed on Jan. 31, 2012, Claims include all types of wallet and other articles incorporating radio frequency shields, including bags, wallets, and passport wallets. A wide range of what are termed RFID shielding materials is claimed, all specified materials being radio frequency reflecting. US20070040653 A1, filed on 16 Jul. 2005 by Kevin Potts, Donald Shore and David Wood, claims priority with respect to U.S. provisional patent application Ser. No. 60/708,578 filed Aug. 16, 2005. This patent includes claims for receptacles incorporating electromagnetic shielding which substantially surrounds enclosed RFID cards or documents. Embodiments include wallets, purses, card holders, pouches and passport wallets, as well as a sheet of material intended to shield existing wallets by being placed in the currency compartment thereof. Patents for devices of this type would appear perilously close to previously published public domain radio frequency shielded items. In none of these types of device is there any mention of the ability to use an RFID document or card without removing it from the wallet or other container.

Patent applications for radio frequency shields also include shielding methods intended to allow the use of an RFID card when in an outer compartment. An example is US20070142103, filed on 29 Jan. 2007 by Oren Livne, claiming priority with respect to U.S. utility application Ser. No. 11/311,769 filed on Dec. 20, 2005. This patent includes claims for a container or bag with compartments having different levels of radio frequency shielding, at least one with what is described with a complete Faraday cage, being lined on all sides with conductive material, and at least one compartment with no shielding. The description states that the shielding is to be achieved by a conductive fabric, with silver coated nylon given as an example. The intent is that items such as RFID badges, cards, and mobile phones can be placed in the unshielded compartment and function without needing to be removed from the compartment. Similar to this is EP1893045 (withdrawn or abandoned 2009) and CN101184410 (withdrawn or abandoned 2010), filed on Mar. 6, 2005 by Steven Gary O'Shea, which includes claims for a radio frequency shielded wallet, money purse, passport wallet or similar receptacle, shielding is accomplished by a conductive lining, with individual sections of the wallet also conductively lined. The description states that the conductive lining is best constructed using a metallic foil. One of the embodiments includes an unshielded compartment or compartments, intended to allow an RFID card within it to be used. Devices of this type are believed to be unworkable as a result of the near field damping effect outlined above. These patents contain no specification for radio frequency absorbing materials in the claims or specific reference to such material in the description.

The most practical previous attempt to produce a radio frequency shield that allows use of a RFID card positioned outside of the shield is EP2400869, and WO2010097342 filed on 19 Feb. 2010, and DE 102009010549 (withdrawn or abandoned on the 30 Apr. 2014), filed on 25 Feb. 2009 by Hesumann, H, Finkenzeller, K, Reiner, H, and Meister, G. This patent includes claims for a hinged, or folding (aufklappbare) radio frequency shield for RFID cards and documents. This shield has two sides, one side includes a metal layer and a ferrite layer (ferritschicht) and this is attached with a hinge of a flexible conducting material to a metal layer (metallplatte), forming the other side of the shield. It is stated that the ferrite layer may be made of a material such as iron oxide or a metallic oxide of manganese or zinc, and is intended to have a high magnetic permeability. This is intended to allow a RFID card or device on the outer side of the ferrite layer to be read by a RFID reader. The shield protects cards on the inside of the device from being read by a RFID reader. There is no mention of the ferrite being distributed through a flexible matrix, and in the absence of this the ferrite material would not be flexible. There is also no mention of the possibility of the ferrite layer being in the form of a graduated shield, or other measures to reduce conductivity, such as distributing the ferrite particles through an insulating matrix, therefore conductivity, and especially surface conductivity of this layer, and as a result reflectivity, may be significant. The ferrite layer covers only one side of one half of the shield.

### BRIEF SUMMARY OF THE INVENTION

The present invention is a robust and sturdy yet thin and flexible planar asymmetric radio frequency shield, in the form of a multi layered sheet, with a minimum attenuation of greater than 100 dB, in terms of penetration through the thickness of the shield, at both 13.57 MHz and 847.5 kHz. The present invention consists essentially of two components, an electrically conductive radio frequency reflecting component and an electrically insulating radio frequency absorbing component, permanently bonded together so that one side of the present invention absorbs radio frequency energy while the other side reflects radio frequency energy. The radio frequency reflecting component is made up of a layer or layers of radio frequency attenuating fabric, and a layer or layers of non-ferrous metallic foil of between one and five mils (0.0254 and 0.127 mm) thickness, bonded together using a flexible adhesive. The radio frequency absorbing layer consists of either a dielectric and/or magnetic radio frequency absorbing powder as filler distributed through an electrically insulating matrix made up of either natural or synthetic rubber, or a similar material. This may be in the form of a graduated shield, and may consist of multiple individual layers bonded together. The radio frequency absorbing and radio frequency reflecting components are bonded together using a flexible adhesive. This shield is intended to be oriented with the radio frequency absorbing side towards the outside of a shielded enclosure.

Embodiments include a shield, in one or more pieces depending on application, covered in a durable, electrically insulating material, placed in the outer currency compartment of a wallet, such that the contents are shielded, while a frequently used RFID card or document, such as a travel or identity card, on the outer, absorbing side of the shield, but within the outer compartment of the wallet, is able to be used without needing to be removed from the wallet. Other embodiments include such a shield integral to a wallet or other container. The shield may also be used in any other circumstance where a thin and flexible asymmetric radio frequency shield of such a nature is deemed to be of utility.

### BRIEF DESCRIPTION OF DRAWINGS

FIG. 1. Schematic diagram showing the layering of elements in the reflective component of the current invention. Layers 1 and 3 consist of non ferrous metallic foil, while layer 2 consists of radio frequency attenuating fabric. These layers are joined together using adhesives. (not to scale)

FIG. 2. Schematic diagram illustrating the attachment of the radio frequency absorbing component (1) to the radio frequency reflecting component (2). These two layers (1& 2) are joined together using adhesives. (not to scale)

FIG. 3. Schematic diagram showing the relationship between the radio frequency reflective layer (2), the radio frequency absorbing layer (1), and the covering material (3) of the present invention in prototype form. (not to scale)

FIG. 4. Schematic cross section showing a common type of wallet (1) with the present invention (2, 3) in place to protect sensitive RFID enabled cards and/or documents (4). The absorbing side of the present invention (2), represented by a thinner line, is oriented towards the outer surface of the wallet when closed, with the radio frequency reflecting side (3), represented by the thicker line, oriented towards the inside, or protected side of the wallet when closed. A frequently used RFID card or document (5), placed between the outer radio frequency absorbing side of the present invention (2) and the outer surface of the wallet (1) is able to be used without requiring it to be removed from the wallet. (not to scale)

FIG. 5. Schematic plan of a common type of wallet (1), as shown in FIG. (6) with the present invention (2) in place, and of a size such that when the wallet is closed by folding about the fold axis (3) both sides of RFID enabled cards and/or documents (4) protected by the present invention are shielded. (not to scale)

FIG. 6. Schematic cross section showing a common type of wallet (1) with the present invention (2, 3) in place to protect sensitive RFID enabled cards and/or documents (4). The absorbing side of the present invention (2), represented by a thinner line, is oriented towards the outer surface of the wallet when closed, with the radio frequency reflecting side (3), represented by the thicker line, oriented towards the inside, or protected side of the wallet when closed. A frequently used RFID card or document (5), placed between the outer radio frequency absorbing side of the present invention (2) and the outer surface of the wallet (1) is able to be used without requiring it to be removed from the wallet. (not to scale)

FIG. 7. Schematic cross section of a common type of wallet, opening along the long axis (4). The present invention (2) is shown as two separate radio frequency shields, with the radio frequency absorbing side, represented by a thinner line, oriented towards the outer surface of the wallet, and the radio frequency reflecting side, represented by the thicker line, oriented towards the inside of the wallet when closed. A frequently used RFID card or document (3), placed between the outer radio frequency absorbing side of the present invention and the outer surface of the wallet (1) is able to be used without requiring it to be removed from the wallet. More sensitive RFID enabled cards or documents (5), placed inside the shielded area, are protected from being either electronically read or detected. (not to scale)

FIG. 8. Schematic cross section of a generic wallet, with the present invention integral to the construction of the wallet (1). The absorbing side of the present invention is oriented towards and attached to the outer surface of the wallet, with the radio frequency reflecting side oriented towards the inside, or protected side of the wallet when closed. A compartment of the wallet located outside the area of the wallet protected by the present invention (2) is able to contain a frequently used RFID card or document (3) such that it is able to be used without requiring it to be removed from the compartment. (not to scale)

### DETAILED DESCRIPTION OF THE INVENTION

The present invention, a flexible asymmetric personal radio frequency data shield, combines a conductive radio frequency reflecting material with a low electrical conductivity (insulating) radio frequency absorbing material, such that one side of the shield reflects radio frequency signals, while the other side absorbs them. The principal data protection is provided by the radio frequency reflecting material, which is placed on the side of the shield towards the protected RFID cards and or documents, that is, towards the inside of the wallet or other enclosure when closed. The reflecting component should have a minimum of 100 dB of attenuation, in terms of penetration through the thickness of the reflecting component, at both 13.57 MHz and 847.5 kHz. The absorbing side of the shield is oriented away from the protected RFID cards, that is, towards the outside of the wallet or other enclosure when closed. The radio frequency absorbing material is intended to reduce the strength of signals returned from the radio frequency reflecting material, and the destructive interference between these and the direct signals transmitted from either the reader or a RFID card or document on or near the absorbing surface. This means that a RFID card or document, such as a transit or identification card, can be read by the reader when in contact with or near the absorbing side of the shield. It is therefore possible to simply ‘swipe’ the entire wallet on the reader when a transit card is placed outside the protected area of the shield, and on the side of the wallet towards the reader.

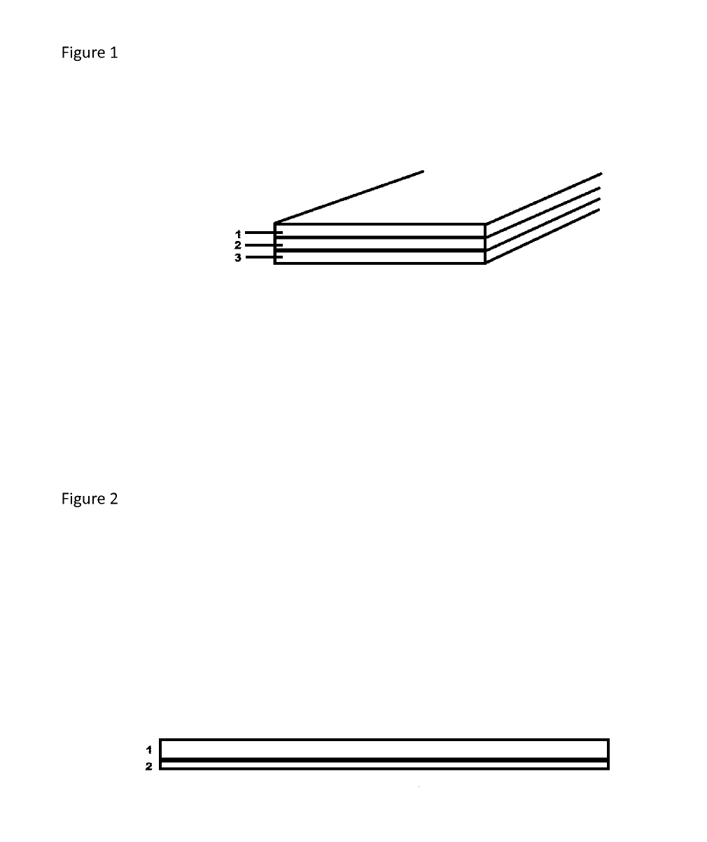

The best method of implementing the present invention consists of several components. A radio frequency reflecting component (FIG. 1) made up of thin non-ferrous metallic foil (1 & 3) attached with a flexible electrically non-conductive adhesive to both sides of a radio frequency attenuating fabric (2). Alternately, this component may consist of a single layer of non-ferrous metallic foil attached to radio frequency attenuating fabric using flexible electrically non-conductive adhesives. Radio frequency attenuating fabrics are available from a number of manufacturers, and have a range of mechanical and physical properties. Copper is a practical and effective metal to use for the purpose of radio frequency reflection, as it has the highest conductivity, and therefore reflectivity, at applicable frequencies of any metal other than silver, is relatively inexpensive, and is readily available in the form of a foil of suitable thickness, with or without adhesive backing. Aluminium is also a practical choice as it has high conductivity, only slightly lower than copper, and is readily available in foils of appropriate thickness. Alternatively, depending on embodiment, metallic gauze, mesh or cloth can be used in the place of foil, as these materials behave in a similar way to foil in terms of radio frequency blocking when the holes in the mesh are very much smaller than the wavelength. Factors important in the choice of RF blocking fabric are mechanical strength, attenuation at applicable frequencies, price and supply. The fabric performs several functions; that of mechanical reinforcement, increasing the overall attenuation of the device, and acting as a substrate to improve adhesive bonding between layers. The use of two layers of copper foil, as shown in FIG. 1, either side of the fabric, would separate the reflectors on the inner and outer sides of the shield, increasing the security of the data shield. The use of a single layer of non-ferrous metallic foil attached to the fabric component would reduce costs. Where a single layer of foil is used there are advantages to having this on the inner, reflecting surface of the shield, unless other considerations preclude this arrangement. A minimum of 100 dB of attenuation in terms of penetration through the shield has been calculated at all frequencies between 1 Hz and 3000 GHz, using either aluminium or copper foil of between 1 and 5 mils (0.0254 and 0.127 mm) thickness, combined with a radio frequency absorbing fabric such as HNG80, HNG100 or Cobaltex, for a single foil layer and single fabric layer, higher shielding values are achieved for multiple layers of foil, separated by fabric layers. Layering the reflective shielding materials in this way creates multiple phase boundaries, with the shielding effectiveness equal to the algebraic sum of the individual shielding values for each layer. The intervening adhesive layers are assumed to have radio frequency attenuation approximately equal to that of free space, as they are non conductive.

The absorbing component (FIG. 2) of the present invention consists of a thin, flexible, electrically insulating radio frequency absorbing layer (1) attached to one side of the reflecting component (2). This layer consists of magnetic or dielectric particles (filler) distributed through a low electrical conductivity (insulating) plastic or rubber matrix, in such a way that the conductivity, especially the surface conductivity, of this layer is minimised, thus minimising radio reflectivity. Literature suggests that dielectric materials, such as finely ground Barite (BaSO₄) and Barium Titanate (BaTiO₃) are suitable to be used as the radio frequency absorbing powder (filler) component, as are various powdered magnetic materials, including ferrites. Prototype testing indicates that finely ground magnetite (Fe₃O₄) is effective when used as the filler. It is important to minimise the radio frequency coefficient of refraction, especially at the outward facing surface (phase boundary) of the absorbing component, so as to minimise the radio frequency reflectivity, and for this reason an increase in filler concentration away from the outer surface, and towards the inner surface, that is the surface attached to the reflecting component of the shield, is highly advantageous. This layer may be applied as a liquid, made by suspending finely ground filler particles in a matrix of liquid rubber (e.g. Latex) or plastic (e.g. synthetic rubber) material. This liquid may be applied directly to the surface of one side of the reflective component, with an adhesive surface treatment, if necessary to assist bonding to the reflective surface, or onto an adhesive coated fabric layer which is attached to the reflecting surface using adhesives. The absorbing layer may also be formed into a discrete layer, with or without a fabric backing, and attached using adhesives. This material may also be sourced from a commercial supplier, as a thin and flexible RF absorbing material, where such material is found to be available with suitable properties including attenuation, conductivity, reflectivity, flexibility, elasticity, resilience, thickness, and cost, and applied as either a single layer or multiple layers. Where these criteria can be met use of commercially sourced radio frequency absorbing materials would simplify manufacturing. Graduation of filler concentration from the inner to outer surfaces may be achieved by gravity separation in the liquid phase before the radio frequency layer becomes solid, magnetic or electrical partitioning, impregnation from one side, layering, or any other process which may be used to produce the desired variation in filler to matrix ratios from the inner to the outer surfaces of this component.

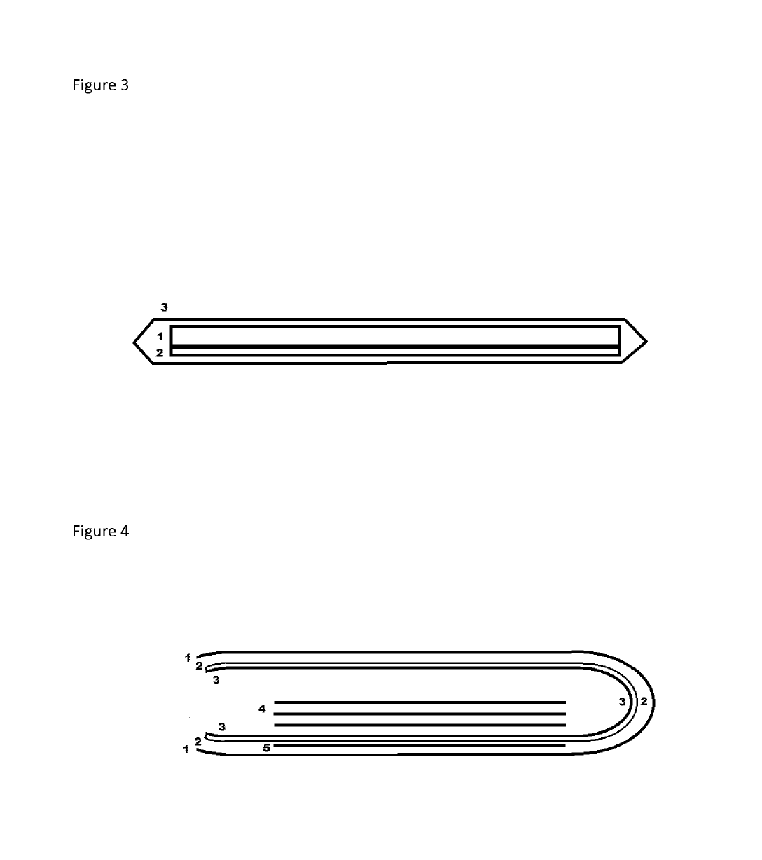

Prototyping (FIG. 3) has made use of liquid latex hand mixed with finely ground magnetite powder, at an initial volume ratio of two parts latex to one of magnetite, applied with a small paint roller, with sufficient layers built up to achieve the desired effect (estimated 6 dB attenuation of return signal at approximately 1.0 mm thickness, equivalent to an approximately two fold reduction in radio frequency energy). Synthetic rubber materials have also been used, hand mixed with magnetite powder, successfully in prototyping. This method allows a graduated radio frequency absorbing layer to be produced, by the simple expedient of adding more liquid matrix material to the matrix and magnetite mixture as layers are built up, minimising conductivity of the surface and thus reflection. This material is applied as a liquid to a thin layer of adhesive sprayed onto the copper foil forming the outer layer of one side of the reflecting component (2). Copper foil of approximately 0.076 mm thickness, calculated attenuation 134 dB at 13.57 MHz, has been attached to both sides HNG80 Radio Frequency blocking cloth, 0.07 mm thickness, attenuation approximately 78 dB at 13.57 MHz, determined experimentally to be effective at applicable frequencies, as well as by extrapolation from manufacturer graphs of measured attenuation, to create the reflective component. Layers have been joined together using 3M ‘Super 77’ spray adhesive. The entire shield, for the purposes of prototyping, has been covered using 3M 1080 car covering vinyl wrap (3). The reflecting side of the shield (1) is marked by a small round window through which the copper is visible, the copper in the window being protected by clear helicopter tape. Overall the shield, in prototype form, measures 21 cm by 8 cm, with the covering extending a further 2 mm around the outside of the device, the overall thickness of the shield, including covering material, is approximately 1 mm. This prototype can be placed into the outermost compartment of a standard male wallet, (FIG. 4) with a transit card (5) placed on the absorbing or outer side of the shield (2) and within the same outermost compartment. The reflecting side of the shield (3) is oriented towards the protected contents of the wallet (4). FIG. 4 shows how the shield (2) fills the outer, currency compartment of the wallet (1), which folds along the axis marked (3). A transport or other frequently used RFID card is shown (4). This prototype has been tested and found to fully function as intended.

The present invention effectively shields RFID cards and documents when protected by the device. The prototype outlined above provides well over the 100 dB of attenuation by convention regarded as complete signal blocking (Learn EMC, 2015), at both 13.57 MHz and 847.5 kHz (calculated value approximately 337 dB full thickness penetration at 13.57 MHz). The copper foil used in constructing the prototype device (0.076 mm thickness) exceeds the skin depth of both the 13.57 MHz reader signal, 0.0177 mm, and the 847.5 kHz return signal, 0.0708 mm (Chemandy Electronics, 2014). The present invention, in prototype form, further provides effective shielding, in excess of 100 dB, across all wavelengths for which values have been calculated between 1 Hz and 3000 GHz.

A travel or identification RFID card placed outside the shielded area of the present invention, that is on the absorbing or outward oriented side and close to or in contact with the surface, can be read easily without needing to be removed from the wallet.

The highly reflective copper inner surface creates a near field damping region which helps protect user data when the wallet is closed, and to a lesser degree when the wallet is open. Tests, using an opal card and the prototype device, indicate that the signal intensity is reduced sufficiently to render the card unreadable up to approximately 5 millimetres from the radio frequency reflecting surface, and to increase read errors and read time as much as 1 cm from the reflecting surface (distances estimated). This is enhanced by a parallel plate effect when the wallet is closed.

Due to the sensitivity of RFID devices to the relative orientation of the plane of the device antenna to the direction of the magnetic field of the reader, signals entering through the open sides of the shield are unlikely to compromise shield security.

When deployed in a wallet the shield tends close up around the open sides, meaning that there is little gap through which signals might penetrate the shield.

The lamination of copper foil to radio frequency blocking fabric mechanically reinforces the copper foil and radio frequency absorbing layers, and adds to the radio frequency attenuation of the shield.

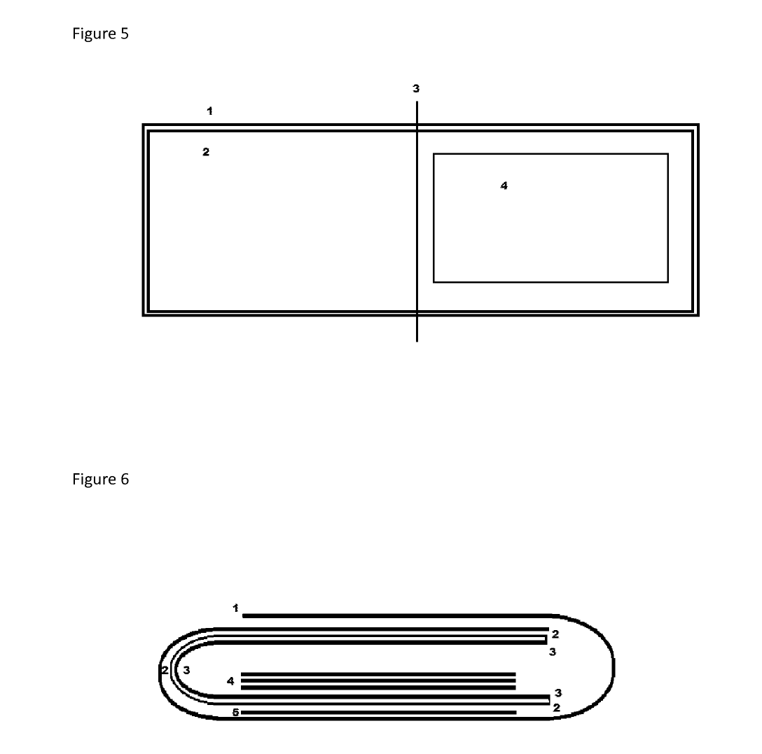

The present invention may be embodied as a thin and flexible radio frequency shield, covered in a durable material, one side of which reflects radio frequency energy, while the other side absorbs radio frequency energy. The present invention is intended to be placed in the outer section of a wallet, with the absorbing side oriented towards the outer surface of the wallet and the radio reflecting side oriented towards the contents or inner side of the wallet. The present invention is intended to be of a size so that both sides of any RFID enabled cards or documents located on the inner or reflecting side are protected from being either read or detected when the wallet is closed, the radio frequency shield being flexible enough to fold with the outer surface of the wallet when the wallet is either opened or closed. The present invention is intended to allow a transport, identification, or other RFID enabled card or document to be placed on the outer, absorbing side of the shield but inside the wallet, such that it can be easily read by a reader unit, being detected, activated and transmitting a signal conveying data necessary for the full utility intended by the suppliers and or manufacturers of the RFID enabled card or document (FIGS. 4, 5 and 6).

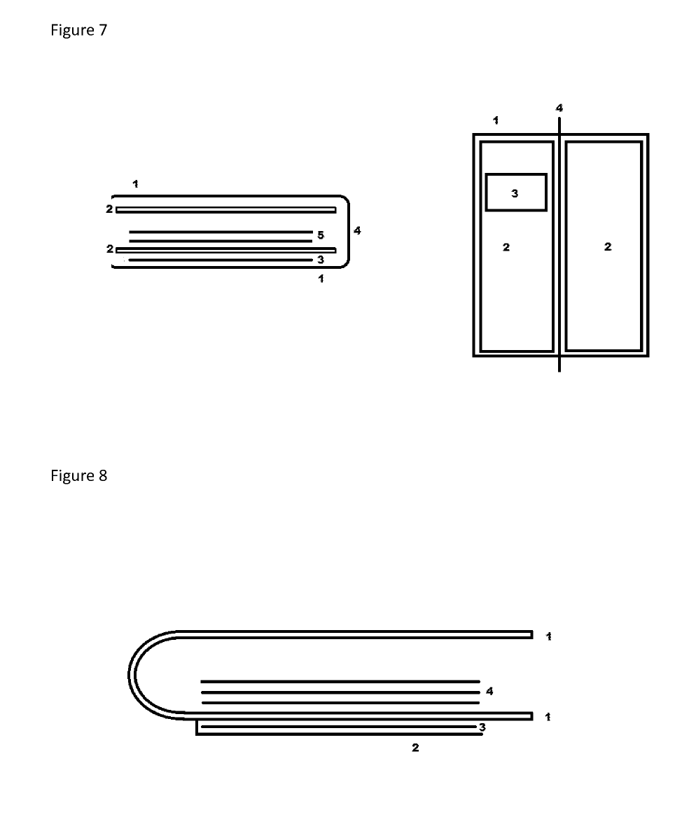

The present invention may be embodied as two or more thin and flexible radio frequency shields, covered in a durable material, one side of which reflects radio frequency energy, while the other side absorbs radio frequency energy (FIG. 7). The present invention may be deployed as separate shields placed in the outer sections of a wallet, with the absorbing sides oriented towards the outer surface of the wallet and the radio reflecting side oriented towards the contents or inner side of the wallet. The present invention is intended to consist of separate shields of a size so that both front and back surfaces of any RFID enabled cards or documents located on the inner or reflecting side are protected from being either read or detected when the wallet is closed. The present invention is intended to allow a transport, identification, or other RFID enabled card or document to be placed on the outer, absorbing side of the shield but inside the wallet, such that it can be easily read by a reader unit, being detected, activated and transmitting a signal conveying data necessary for the full utility intended by the suppliers and or manufacturers of the RFID enabled card or document.

The present invention may be embodied as a thin and flexible radio frequency shield, one side of which reflects radio frequency energy, while the other side absorbs radio frequency energy, incorporated into the construction of a wallet (FIG. 8). The present invention is intended to be oriented so that the absorbing side of the shield is oriented away from the protected contents of the wallet, and the reflecting side is oriented towards the protected contents of the wallet. A compartment or section of the wallet outside the protected area of the wallet, that is on the absorbing side of the shield, would allow a transport, identification, or other RFID enabled card or document to be secured on the outer, absorbing side of the shield, but inside a compartment of the wallet, such that it can be easily read by a reader unit, being detected, activated and transmitting a signal conveying data necessary for the full utility intended by the suppliers and or manufacturers of the RFID enabled card or document.

The present invention may be embodied as a thin and flexible radio frequency shield, one side of which reflects radio frequency energy, while the other side absorbs radio frequency energy, used in circumstances and applications where these properties are desirable, and of dimensions to suit said application. Said applications including, but not limited to: containers for electronic equipment; protective coverings for electronic equipment; protective coverings for electronic equipment associated with sensitive scientific measurements where the electronic equipment requires protection, or shielding, and the presence of a metallic cover for said equipment may disrupt measurements; protective tents or covers for electronic equipment where it is desirable that the presence of a shielded structure be not readily detectable.

The present invention is of utility in the prevention of financial and identity fraud. It is intended to prevent the theft of data from RFID enabled cards and documents, and thus the commission of fraud, of either a financial or identity nature. The prevention of financial fraud is of relevance to the banking industry, amongst others, as the liability for fraud committed using illegally obtained information from RFID enabled banking cards and documents is often assumed by individual banks. The prevention of fraud, of either a financial or identity nature is of utility to both businesses and individuals.

The present invention is of utility to the transport industry, in allowing people to more easily and rapidly pass through RFID enabled ticketing gates, such as those associated with either Opal or Oyster cards. The present invention eliminates the need for such cards to be removed and replaced in commuter wallets, and also enhances scanning of such cards by separating them from other commonly carried RFID cards and documents, such as credit cards. The ability of commuters to simply swipe or tap their wallet at ticketing gates improves utility for the individual commuter as well as for the transport system at busy times.

The present invention may have utility in the defence, intelligence, scientific or other industries where electronic data security and/or the shielding of either passive or active electronic device or devices from detection, or electromagnetic interference, and any data contained on said device or devices secured, is desirable. The present invention may be deployed in such a manner that the presence of a shielded enclosure is difficult to detect electronically.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated or described.

### REFERENCES CITED

| U.S. PATENT DOCUMENTS | | | |
|---|---|---|---|
| 20070040653 | August 2005 | Potts et al. | |
| 20070142103 | January 2007 | Livne | |
| 20140034520 | January 2012 | Sciculina | |
| FOREIGN PATENT DOCUMENTS | | | |
| EP1893045 | June 2005 | O'Shea | EP |
| CN101184410 | June 2005 | O'Shea | CN |
| EP2400869 | February 2009 | Heusmann et al. | EP |
| W02010097342 | February 2009 | Heusmann et al. | WO |
| EP2809193 | January 2012 | Sciculina | EP |
| W02013116532 | January 2012 | Sciculina | WO |

### Other References

Atmel Corporation, 2005. Requirements of ISO/IEC 14443 Type B Proximity Contactless Identification Cards, Application Note, Rev. 2056B-RFID-11/05, accessed Mar. 13, 2015, http://www.atmel.com/Images/doc2056.pdf
Department of the Air Force, 1989. Electronic Combat Principles, Volume III, Systems Phase, USAF Test Pilot School Edwards AFB, CA, AFP 51-45, ADA320035.pdf, accessed Mar. 13, 2015, http://www.google.com.au/url?sa=t&rct=j&q=&esrc=s&source=web&cd=28(cad=rja&uact=&&ved=0CCIQFjAB&url=http%3A%2F%2Fhandle.dtic.mil%2F100.2%2FADA320035&ei=YkAFVZu0HNXq8AWRpYGgAw&usg=AFQjCNEe0rPFZJfl8cVUI0jQb1TRaLIxUw&sig2=swfzWTGe0DawWdMMRwSCqg
Encyclopaedia Britannica Online, s. v. “hysteresis”, accessed Mar. 13, 2015, http://www.britannica.com/EBchecked/topic/280201/hysteresis.
Fox, J, C, 2015, Shielding Effectiveness Calculator, The Clemson University Vehicular Electronics Laboratory, accessed Mar. 13, 2015, http://www.clemson.edu/ces/cvel/emc/calculators/SE_Calculator/index.html
Greenberg, A. 2012. Hacker Demos Android App That Can Wirelessly Steal And Use Credit Cards' Data. Forbes, accessed Mar. 13, 2015, http://www.forbes.com/sites/andygreenberg/2012/07/27/hacker-demos-android-app-that-can-read-and-use-a-credit-card-thats-still-in-your-wallet/
Kantor, A. 2003, Tiny transmitters give retailers, privacy advocates goose bumps. CyberSpeak, USA today. Posted Dec. 19, 2003 12:30 PM, accessed Mar. 13, 2015, http://usatoday30.usatoday.com/tech/columnist/andrewkantor/2003-12-19-kantor_x.htm
Kong, I, HjAhmada, S, HjAbdullah, M, Hui, D, Ahmad, Yusoff, A, N, DwiPuryanti, D, 2010. Magnetic and microwave absorbing properties of magnetite-thermoplastic natural rubber nanocomposites. Journal of Magnetism and Magnetic Materials, 322 (2010) 3401-3409, accessed Mar. 13, 2015, http://site.icce-nano.org/Clients/iccenanoorg/hui%20pub/2010%20magnetic%20and%20microwave%20absorbing%20properties%20of%20magnetite-thermoplastic%20natural%20rubber%20nanocomposites.pdf
Learn EMC, 2015, Shielding Theory, learnemc.com, accessed Mar. 13, 2015, http://www.learnemc.com/tutorials/Shielding01/Shielding_Theory.html
MacFarquahr, N. 1995, Latest Tool of Shoplifters: Metal in Bags, The New York Times, Mar. 11 1995, accessed Mar. 13, 2015, http://www.nytimes.com/1995/03/11/nyregion/latest-tool-of-shoplifters-metal-in-bags.html
Offsure (ed.), 2015. Hysteresis, Wikipedia, accessed Mar. 13, 2015, http://en.wikipedia.org/w/index.php?title=Hysteresis&oldid=649505734
Oxley, C. H, Williams, J, Hopper, R, Flora, H, Eibeck, D, and Alabaster, C, 2007, The Measurement of the Reflection and Transmission Properties of Conducting Fabrics to Milli-Metric Wave Frequencies, Staff publications—Cranfield Defence and Security, Shrivenham, accessed Mar. 13, 2015, http://dspace.lib.cranfield.ac.uk/handle/1826/7530
Pawlarczyk, J. E. 2013, RFID Blocking Wallets: Too Good to be True? Truth is Cool, May 11 2013, accessed Mar. 13, 2015, HTTP://TRUTHISCOOL.COM/RFID-BLOCKING-WALLETS-TOO-GOOD-TO-BE-TRUE
Rjwilmsi (ed.), 2015, Magnetite. Wikipedia, accessed Mar. 13, 2015, http://en.wikipedia.org/w/index.php?title=Magnetite&oldid=646785663,
Schneyderman, Ya. A. 1965. Radio-Absorbing Materials, Zarubezhneya Radioelektron, USSR, Nr 4, 1965, 115-135. Machine translation, published July 1985, NASA STI, Recon Technical Report, 86, accessed Mar. 13, 2015, http://www.dtic.mil/dtic/tr/fulltext/u2/a157496.pdf, ref. FTD-ID(RS)T-1326-84
Spy Blog, Feb. 21, 2004. Foiling the Oyster Card, RFIDbuzz.com, accessed 13 Mar. 2015, http://www.rfidbuzz.com/news/2004/rfid_in_the_london_transport_oyster_cards.html
Su, C, Yuan, Q, Gan, W, Dai, D, Huang, J, Huang, Y, 2012. Study on a Composite Fiberboard with Multiple Electromagnetic Shielding Effectiveness. The Open Materials Science Journal, 2012, 6, 44-49, accessed, 13 Mar., 2015, http://benthamopen.com/contents/pdf/TOMSJ/TOMSJ-6-44.pdf
Weibler, J. 1993. Properties of Metals Used For RF Shielding. EMC Test and Design, December 1993, accessed Mar. 13, 2015, http://www.etslindgren.com/pdf/emctd_1293_weibler.pdf
Young, H. D. Freedman, R. A. 2000, Sears and Zemansky's University Physics, Tenth Edition. Addison Wesley, San Francisco.
Yshield, 2015, Measurement report screening attenuation, accessed Mar. 13, 2015, http://www.yshield.com/pdf/db/YSHIELD-HNG80-DB.pdf

1. A flexible asymmetric radio frequency shield, offering a high level of security in terms of radio frequency penetration through the thickness of the shield, at radio frequencies relevant to the particular deployment, embodiment, use or application of said shield, being in the form of a multi layered sheet, made up of a flexible high electrical conductivity radio frequency reflecting component and a flexible low electrical conductivity radio frequency absorbing component, attached together in such a way that one side of said shield reflects radio frequency signals while the other side absorbs radio frequency signals, said radio frequency reflecting component consisting of a layer or layers of electrically conducting materials such as electrically conducting radio frequency attenuating fabric, metallic foil, conductive polymers or other suitable electrically conducting materials, or a combination of these, said absorbing component consisting of dielectric or magnetically susceptible particles, or other radio frequency absorbing particles, or a combination of these, distributed through a flexible low electrical conductivity matrix material, as a single layer or as multiple layers, such that an appropriate reduction of electromagnetic radio frequency energy in terms of signal return from the reflecting component is achieved at appropriate frequencies to fulfil the requirements of a particular deployment or embodiment of said shield, and in addition said shield may be furnished with, where deemed appropriate, a layer or layers of any other material or materials, present for reasons not directly connected with the radio frequency shielding functions of the present invention, either internally or externally, and these may extend over part of, the entirety of, or beyond the radio frequency shielding area of said shield, and all layers making up said shield to be permanently bonded together using flexible non-conductive adhesives, or some other suitable method, and further said shield may be furnished with any fittings or attachments deemed appropriate to a particular deployment or embodiment.

2. A flexible asymmetric radio frequency shield, according to claim 1, in one or more pieces depending on application, deployment or embodiment, intended for use in a portable container or enclosure of utility in transporting, protecting or storing RFID enabled cards and/or documents such as a wallet, card wallet, billfold, purse, bag, case, box, pouch, pocket or any other container or enclosure used for such purposes, and either integral to said container or enclosure or as a separate removable item or items, said shield being intended to be oriented with the radio frequency reflecting side towards the interior of said container or enclosure and the radio frequency absorbing side oriented towards the exterior of said container or enclosure when closed, fastened, secured, shut or otherwise placed into a condition generally intended for the security, transport, or protection of the contents of said container or enclosure, whether rendering said, enclosure or container into such a condition involves a change in conformation of an element or elements of said container or enclosure or otherwise, and of a size or sizes such that RFID enabled cards or documents within the shielded area of said container or enclosure are protected with respect to the security of any stored data on said RFID cards and or documents, said radio frequency shield or radio frequency shields being configured so as to allow use of an RFID card or cards or RFID enabled document or documents, or an item or items of a similar nature, when placed on the outer absorbing side of said shield, but within said container or enclosure or within an external compartment of said container or enclosure, such as to allow the reception and transmission of all radio frequency signals necessary to allow full RFID functionality.

3. A flexible asymmetric radio frequency shield, according to claim 1, intended for use in a container or enclosure of utility in transporting, protecting or storing any electronic data, equipment or device, and either integral to said container or enclosure or as a separate removable item or items.
